(19) United States
(12) Patent Application Publication
(10) Pub. No.: US 2026/0266167 A1
(43) Pub. Date: Sep. 10, 2026

(54) DEVICE USED TO CONTROL DAMAGING HYDRAULIC PULSATIONS IN MANIFOLDED MULTI PUMP SYSTEMS USED IN HYDRAULIC FRACTURING

(71) Applicant: Performance Pulsation Control, Inc., Richardson, TX (US)

(72) Inventors: John Thomas Rogers, Garland, TX (US); James Barlow, Dallas, TX (US); Jeff Robinson, Dallas, TX (US)

(21) Appl. No.: 19/556,997

(22) Filed: Mar. 4, 2026

Related U.S. Application Data
(60) Provisional application No. 63/766,914, filed on Mar. 4, 2025.

(51) Int. Cl. E21B 43/26; F16L 55/05

(52) U.S. Cl. CPC E21B 43/2607; F16L 55/05

(57) ABSTRACT

To reduce pulsation amplitudes to the pumps and from pumps to the downstream components, as well as to provide greater flexibility in integration of pulsation control dampeners with other elements of an overall pump system, when a plurality of pumps operate together using a common manifold, the hydraulic interaction of the pumps is given special consideration beyond the pulsation control techniques and equipment that may be used for a single pump. To improve the life expectancy of the manifold and affiliated items used in a multi pump system, an acoustic/pulsation control device inhibits or mitigates damaging transient pulsations. The acoustic/pulsation control device is installed to control the pulsations and thus reduce damaging vibrations.

### CROSS-REFERENCE TO RELATED APPLICATION(S) AND CLAIM OF PRIORITY

This application claims priority under 35 U.S.C. § 119(e) to U.S. Provisional Patent Application No. 63/766,914 filed on Mar. 4, 2025. The above-identified provisional patent applications are hereby incorporated by reference in their entirety.

### TECHNICAL FIELD

This disclosure relates generally to pulsation control during the operation of reciprocating pump fluid transfer systems. More specifically, this disclosure relates to pulsation control products used on fluid transfer system utilized in hydraulic fracturing.

### BACKGROUND

Pulsation control in reciprocating pump fluid transfer systems is in constant need of improvement. Among the desirable improvements are reduced pulsation amplitudes to the pumps and from pumps to the downstream system, as well as greater flexibility in integration of pulsation control dampeners with other elements of an overall pump system.

When multiple pumps are operated together using a common manifold, the hydraulic interaction of the pumps requires special consideration beyond the pulsation control techniques and equipment that may be used for a single pump.

The most common approach to controlling systems with multiple pumps is to use a device on every pump attached to the manifold. This technique has been shown to not be as effective as desired at controlling the system pulsations, and is also not commercially viable given the number of pumps in operation at a typical location.

### SUMMARY

To improve the life expectancy of the manifold and affiliated items used in a multi-pump system, a device is used to control damaging transient pulsations. These transient pulsations (pressure waves) interact with the structure of the system causing vibrations that, over time, will cause catastrophic damage to the system.

The device may be installed in the manifold so that the pumped fluid will pass into and then out of the device. The location of the device within the manifold impacts the effectiveness as, when used incorrectly, the pulsations (and thus vibrations) could be amplified and cause even more damage then was experienced in the system without the device.

In some embodiments, the inlet and outlet for the device may not be concentric to each other.

In some embodiments, the fluid flow within the device is restricted, diverted, or modified in some way while traveling thru the device.

In some embodiments, the device may use a single fluid inlet and attach to the manifold by a single point of hydraulic interchange.

In some embodiments, the device may use an internal membrane to separate the pumped fluid from a substance more compressible than the pumped fluid.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term "couple" and its derivatives refer to any direct or indirect communication between two or more elements, whether or not those elements are in physical contact with one another. The terms "include" and "comprise," as well as derivatives thereof, mean inclusion without limitation. The term "or" is inclusive, meaning and/or. The phrase "associated with," as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase "at least one of," when used with a list of items, means that different combinations of one or more of the listed items may be used, and only one item in the list may be needed. For example, "at least one of: A, B, and C" includes any of the following combinations: A, B, C, A and B, A and C, B and C, and A and B and C. The terms dampener and stabilizer may be used interchangeably. The terms pulsation dampener, dampeners, suction dampener, suction stabilizer, or stabilizers may be used interchangeably.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagrammatic view of a drilling system including a device used to control pulsations in a multi-pump system according to various embodiments of the present disclosure;

FIGS. 2A through 2D diagrammatically illustrate permutations for use of at least one acoustic/pulsation control device within a monoline between a multi-pump pump system and a borehole according to various embodiments of the present disclosure;

FIGS. 3 and 3A-3B depict one embodiment of an acoustic/pulsation control device to control pulsations in a multi-pump system according to various embodiments of the present disclosure; and

FIG. 4 depicts the exemplary acoustic/pulsation control device of FIGS. 3 and 3A-3B installed within the piping for a monoline connecting a multi-pump system to a borehole according to various embodiments of the present disclosure.

### DETAILED DESCRIPTION

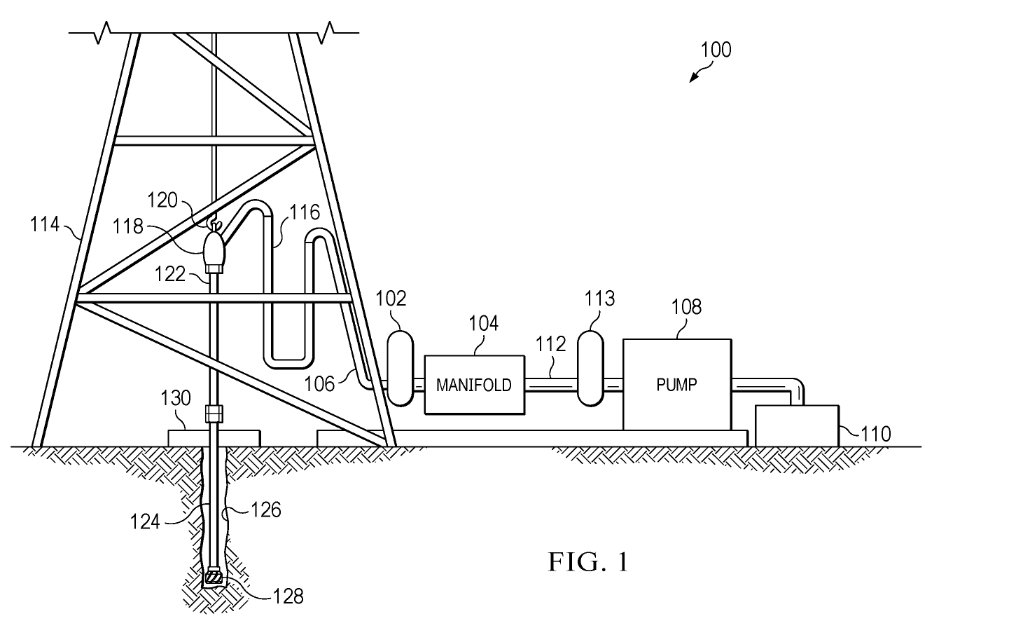

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably- arranged structure that can be used to control or partially control pumped fluid pulsation amplitudes.

FIG. 1 illustrates a diagrammatic view of a drilling system 100 including a device used to control pulsations in a multi-pump system according to various embodiments of the present disclosure. The embodiment of the drilling system 100 illustrated in FIG. 1 is for illustration only. FIG. 1 does not limit the scope of this disclosure to any particular implementation of a drilling system. Although referred to as a "drilling" system, the drilling system 100 may be used for a variety of operations other than just drilling a borehole. For example, the drilling system 100 may also be used for operations such as fracturing ("fracking"). Therefore, those skilled in the art will recognize that use of the term "drilling" is not intended to be limiting.

Referring to FIG. 1, the drilling system 100 includes at least one acoustic/pulsation control device 102 located between the (combined) discharge of a pump system 108 and a borehole 126. The pump system 108 includes at plurality of pumps as discussed below, each of which is configured to pump fluid into the single borehole 126. Accordingly, at some point within the piping for the drilling system 100, a "monoline" is formed to carry pumped fluid from any of the pumps into the borehole 126. The at least one acoustic/pulsation control device 102 is located within or along that monoline.

More generally, the drilling system 100 of FIG. 1 may include at least one fluid reservoir 110 containing fluid to be pumped into the borehole 126. In many of the applications of interest, the fluid reservoir 110 contains fracturing fluids used to fracture rock formations within the borehole 126. The fluid reservoir 110 may alternatively contain drilling fluid (a/k/a "mud," fluids pumped down a well currently being drilled to keep a drill bit from overheating, to provide lubrication to the drill bit, and to remove rock cuttings to the surface). The fluid reservoir 110 is therefore illustrated diagrammatically, intended to represent one or multiple reservoirs (e.g., one for fracturing fluid and one for drilling fluid).

The pump system 108 is configured to pump fluid from the fluid reservoir 110 into the borehole 126. At least one discharge line 112 connected to the pump system 108 carries the pumped fluids. As discussed below, the at least one discharge line 112 includes a discharge connection from each pump within the pump system 108. As noted above, at some point between the pump system 108 and the borehole 126, the discharge lines from each pump within the pump system 108 are connected to form a monoline carrying pumped fluid into the borehole 126. The at least one acoustic/pulsation control device 102 is situated within or along that monoline.

In the example of FIG. 1, the drilling system 100 includes a standpipe manifold 104 and a standpipe 106 situated between the pump system 108 and the borehole 126. The illustration showing the at least one acoustic/pulsation control device 102 as situated between the standpipe manifold 104 and the standpipe 106 is not intended to imply a limitation with regard to the location of the at least one acoustic/pulsation control device 102.

A conventionally located pulsation dampener 113 (located along the discharge line 112, at the outlet of pumps within the pump system 108 and before the standpipe manifold 104) is shown at the outlet of pumps within the pump system 108 in FIG. 1, to indicate that the at least one acoustic/pulsation control device 102 may operate in conjunction with such a conventional pulsation dampener 113. However, the at least one acoustic/pulsation control device 102 of the present disclosure may also function as intended even in the absence of such a pulsation dampener 113.

The pumps within the pump system 108 pump fluid from the fluid reservoir 110 through the (combined) discharge line 112 in the direction of a rig 114. More than one pump is utilized in a drilling system 100 to continue operations upon failure of a single pump 108. The standpipe manifold 104 and the standpipe 106 are installed downstream from the discharge line 112 of the pump system 108 and is attached to and/or coupled in fluid communication with the rig 114 and the borehole 126. The standpipe manifold 104 may receive a plurality of different fluid streams from different pumps within the pump system 108. The standpipe manifold 104 may then combine all of the fluid streams together to send a single fluid stream up the standpipe 106. Other functions traditionally performed by the standpipe manifold are to provide an auxiliary connection for a supplementary pump and, in systems with multiple standpipes providing operational redundancy in case of failure of one standpipe, to switch fluid flow paths from one standpipe to another. However, those skilled in the art understand that some systems dispense with the standpipe manifold, and simply bring the outlet flows of multiple mud pumps together in a single line somewhere near the mud pumps or downstream, with the combined flow then traveling in a single line to the substructure and upwards toward the standpipe,

When the fluid streams from multiple pumps are combined (in a standpipe manifold or without one), the pulsations in the resulting combined fluid flow can be enlarged based on the different pulsations of the pumps being used. For example, the different types or sizes of pumps can be used in a single drilling system 100, which would cause variations or pulsations in the fluid flow through the pipe. The pumps could also be located at different distances from the rig 114. The pumps could begin at different times, operating off cycle from other pumps, or simply be operating at different stroke lengths. Any of these operating parameters would affect the flow of fluids into the borehole 126, causing pulsations.

The standpipe 106 may be installed on the rig 114 and travel up the rig 114 to provide the pumped fluid through a rotary hose 116, connected to a swivel 118 that is coupled to a rotary hook 120. In the diagram shown, the standpipe 106 receives discharge from the standpipe manifold, which can include multiple discharges to the standpipe 106 in case of failure in part of the standpipe manifold 104 or associated pipeline.

The swivel 118 may serve as a passageway for the fluid stream into a Kelly drive 122 (or just "Kelly"). The Kelly 122 connects to a borehole pipe string 124. Pumped fluid passes through the Kelly 122 and the borehole pipe string 124 down the borehole 126 to one or more devices 128 (e.g., a drill bit, a measurement tool, etc.) disposed at a far end of the borehole pipe string 124. The Kelly 122 is typically rotated by a rotary table 130. More recent systems may include a top drive to rotate the borehole pipe string 124 as an alternative to the rotary table and Kelly drive, and the present disclosure is applicable to such top drive configurations as well.

As fluid is combined into a single stream and sent to the standpipe 106, significant energy and pulsation amplitudes may be created by the combining of the streams from the different pumps or transferred directly to the standpipe 106, which is then transferred to the rest of the system downstream. The pulsation amplitudes produced may be greater as more pumps are used to provide fluid reaching the standpipe manifold 104, as pulsations from multiple pipes receiving fluid from the multiple pumps come together and accumulate, and are then transferred to the standpipe 106. These pulsations can cause wear and damage to components, including the connections near the swivel 118, Kelly 122, and other components such as a wash pipe and wash pipe packing (seals) (both not shown) that serves as a conduit for fluid through the swivel 118. Instruments used for monitoring and measuring operations within the borehole 126 can also be affected by the pulsations. Even the smallest fluid pressure pulsations can affect the measurement readings. Reducing or elimination acoustic noise and pulsation levels allows for easier signal detection by the measurement while drilling (MWD) and logging while drilling (LWD) tools located in the borehole 126. Reduced interference with such downhole instruments, which may pick up residual pressure pulsations that skew detections and generated data from the downhole instruments, improves operation.

While the at least one acoustic/pulsation control device 102 is shown in FIG. 1 as connected at the outlet of the manifold 104, the at least one acoustic/pulsation control device 102 may alternatively be connected at the inlet of the manifold 104.

FIG. 1 illustrates an example of a drilling system including at least one acoustic/pulsation control device located within a monoline to control pulsations from a multi-pump pump system according to various embodiments of the present disclosure. The embodiment illustrated in FIG. 1 is for illustration and explanation only. FIG. 1 does not limit the scope of this disclosure to any particular implementation.

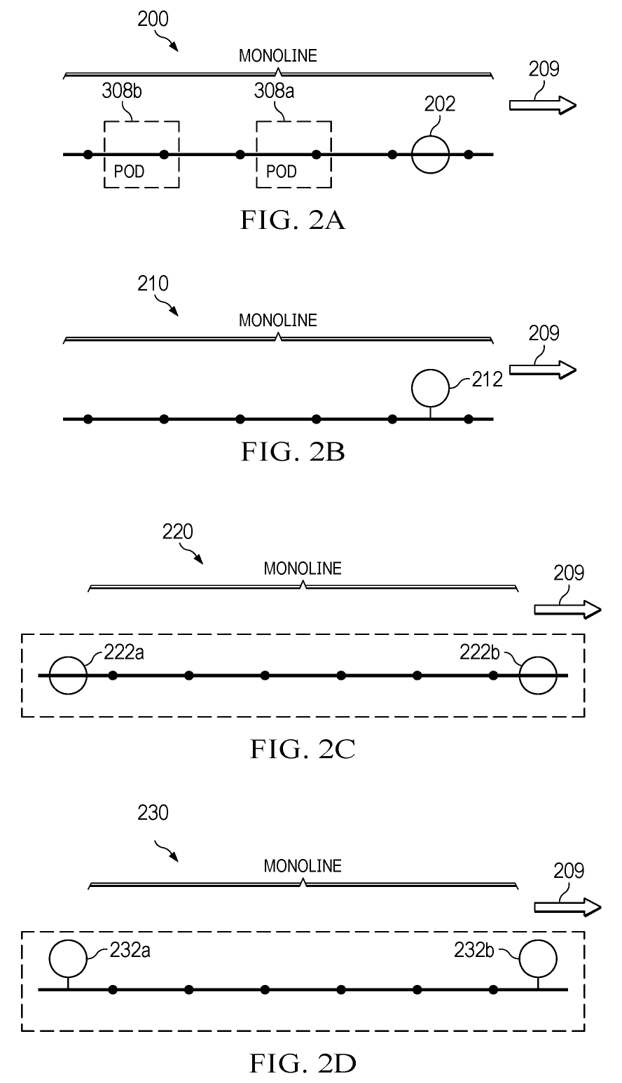

FIGS. 2A through 2D diagrammatically illustrate permutations for use of at least one acoustic/pulsation control device within a monoline between a multi-pump pump system and a borehole according to various embodiments of the present disclosure. The permutations illustrated in FIGS. 2A through 2D are for illustration only. FIGS. 2A through 2D do not limit the scope of this disclosure to any particular configuration.

The direction 209 of discharge flow is indicated in each of FIGS. 2A through 2D, together with a monoline along which connections to one of a plurality of pumps (each represented by a solid black circle) exist in the respective embodiments. The acoustic/pulsation control device 202 in FIG. 2A, the acoustic/pulsation control device 212 in FIG. 2B, the acoustic/pulsation control devices 222a and 222b in FIG. 2C, the acoustic/pulsation control devices 232a and 232b in FIG. 2D each correspond to the at least one acoustic/pulsation control device 102 in FIG. 1 for the respective embodiment.

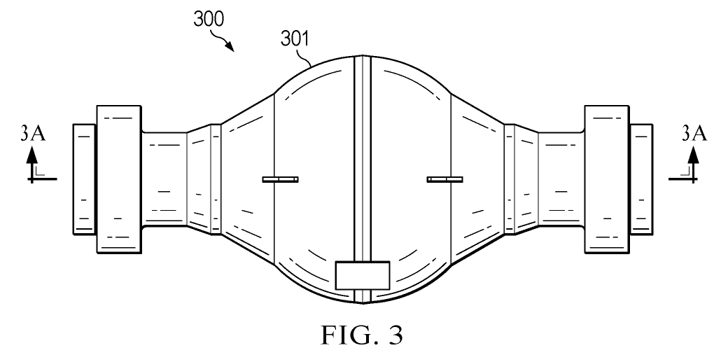

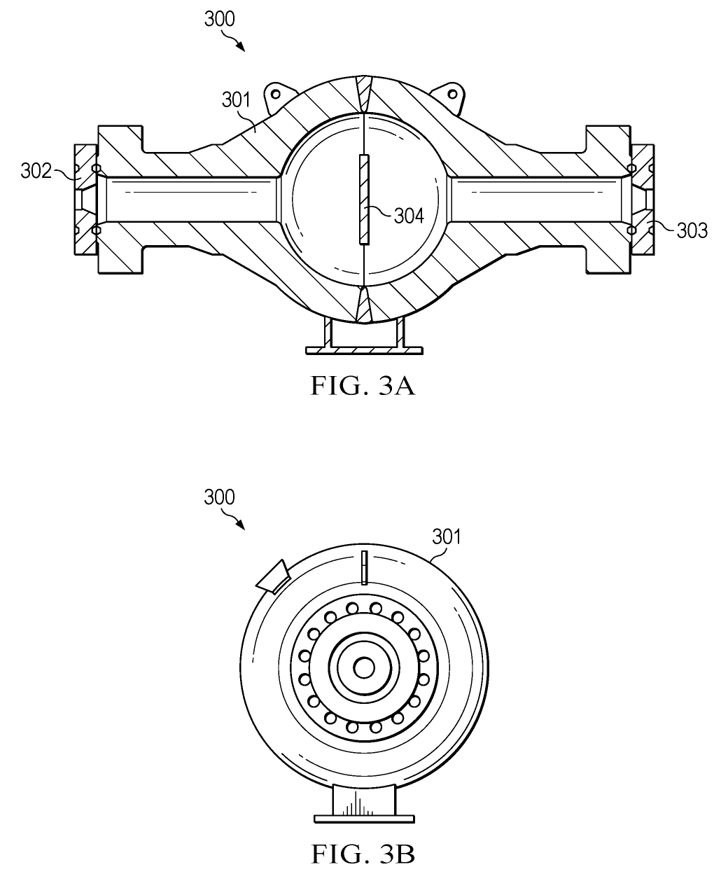

The embodiment 200 of FIG. 2A diagrammatically depicts an inline, flow-through acoustic/pulsation control device 202, while the embodiment 210 of FIG. 2B diagrammatically depicts an inline appendage acoustic/pulsation control device 212. The embodiment 220 of FIG. 2C illustrates that an inline, flow-through acoustic/pulsation control device 222a, 222b may be connected at the start of a series of pump connections (between manifolded pumps each represented by the solid dots) along the monoline, at the end, or both. Similarly the embodiment 230 of FIG. 2D illustrates that an inline, appendage acoustic/pulsation control device 232a, 232b may be connected at the start of a series of pumps along the monoline, at the end, or both. FIGS. 2A and 2B illustrate that at least one pump connection to the monoline may exist downstream from the acoustic/pulsation control device 202, 212. FIG. 2A illustrates that one or more pump connections 308a, 308b may include an acoustic/pulsation control device (a pulsation orifice device or (POD)) of the type described below in connection with FIG. 3 as part of the connection between the pump outlet and the monoline. The embodiment 220 of FIG. 2C, the embodiment 220 of FIG. 2C, and the embodiment 230 of FIG. 2D may each also include acoustic/pulsation control device at the start of a series of pump connections (between manifolded pumps that are, again, each represented by the solid dots) along the monoline, at the end, or both.

FIGS. 2A through 2D illustrate examples of connection of using at least one acoustic/pulsation control device within a monoline between a multi-pump pump system and a borehole according to various embodiments of the present disclosure. The embodiments illustrated in FIGS. 2A through 2D are for illustration and explanation only. FIGS. 2A through 2D do not limit the scope of this disclosure to any particular configuration.

FIGS. 3 and 3A-3B depict one embodiment of an acoustic/pulsation control device to control pulsations in a multi-pump system according to various embodiments of the present disclosure. The embodiment of the acoustic/pulsation control device 300 depicted in FIGS. 3 and 3A-3B is for illustration only. FIGS. 3 and 3A-3B do not limit the scope of this disclosure to any particular implementation of an acoustic/pulsation control device.

FIG. 3 is a side view of the exemplary acoustic/pulsation control device 300. FIG. 3A is a cross-sectional view of FIG. 3 taken at section lines A-A, and FIG. 3B is an end view of FIG. 3A.

The exemplary acoustic/pulsation control device 300 depicted in FIGS. 3 and 3A-3B includes a flow-through body 301 with an inlet and an outlet allowing fluid flow into and out of an internal cavity larger than the inner diameter of pipe connections into and out of the flow- through body 301. The inner diameter of the internal cavity, at the largest point, is preferably more than twice the inner diameter of the pipe connections, as shown in FIG. 3A. It should be noted that the inner diameter of the inlet pipe connection and the inner diameter of the outlet pipe connection need not be the same, and the inner diameter of the internal cavity is at least twice the larger of the inner diameter of the inlet pipe connection and the inner diameter of the outlet pipe connection. The internal cavity is preferably generally spherical.

As best seen in FIG. 3A, the inlet and outlet of the exemplary acoustic/pulsation control device 300 each include a flow control device 302, 303. In the example shown, each flow control device 302, 303 is an orifice having a constant internal diameter in a region furthest from the internal cavity of the body 301 and a tapered internal diameter in a region closest to the internal cavity of the body 301. In the example shown, the region with the tapered internal diameter has a larger cross-section at an end closer to the internal cavity than at the end furthest from the internal cavity. The flow control devices 302, 303 each create a fluid pressure change during passage of pumped fluid through the respective inlet or outlet.

The exemplary acoustic/pulsation control device 300 also includes an internal baffle plate 304 positioned in the internal cavity within the body 301. The internal baffle plate 304 obstructs direct fluid flow from the inlet to the outlet of the body 301, forcing fluid to flow around edges of the internal baffle plate 304 when passing through the internal cavity. The internal baffle plate 304 mitigates the impact of pressure pulsations within the pumped fluid at the inlet on pumped fluid at the outlet. The internal baffle plate 304 has a diameter not more than two-thirds of the inner diameter of the internal cavity, at the largest point. The internal baffle plate 304 may be formed from a substance more compressible than the pumped fluid, such that pressure of fluid pumped through the internal cavity compresses the internal baffle plate 304.

FIGS. 3 and 3A-3B illustrate one example of an acoustic/pulsation control device for use within a monoline between a multi-pump pump system and a borehole according to various embodiments of the present disclosure. The embodiments illustrated in FIGS. 3 and 3A-3B are for illustration and explanation only. FIGS. 3 and 3A-3B do not limit the scope of this disclosure to any particular configuration.

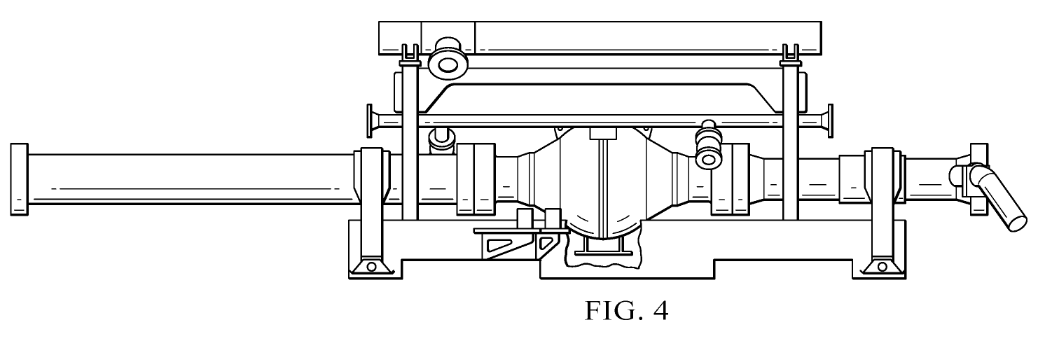

FIG. 4 depicts the exemplary acoustic/pulsation control device of FIGS. 3 and 3A-3B installed within the piping for a monoline connecting a multi-pump system to a borehole according to various embodiments of the present disclosure.

Although the figures illustrate different examples, various changes may be made to the figures. For example, the pulsation control stabilizer can include any number of each component in any suitable arrangement. In general, the figures do not limit the scope of this disclosure to any particular configuration(s). Moreover, while figures illustrate operational environments in which various pulsation control stabilizer features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words "means for" are followed by a participle. Use of any other term, including without limitation "mechanism," "module," "device," "unit," "component," "element," "member," "apparatus," "machine," "system," "processor," or "controller," within a claim is understood by the applicants to refer to structures known to those skilled in the relevant art and is not intended to invoke 35 U.S.C. § 112(f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A system, comprising:
a manifold;
a plurality of pumps fluidically coupled to the manifold; and
a pulsation control device within a connection to at least one of the plurality of pumps, the pulsation control device comprising:
an internal cavity having an inlet connection and an outlet connection, the internal cavity having an inner diameter at least twice a larger of an inner diameter of the inlet connection and an inner diameter of the outlet connection;
a first flow control device within the inlet connection;
a second flow control device within the outlet connection; and
a baffle plate mounted within the internal cavity to force fluid flow through the internal cavity around edges of the baffle plate.

2. The device according to claim 1, wherein the pulsation control device is mounted at any location along the manifold including either ends or along its length.

3. The device according to claim 1, wherein the pulsation control device is mounted in line with the flow passing thru the device.

4. The device according to claim 1, wherein the pulsation control device is mounted adjacent to the flow.

5. The device according to claim 1, wherein flow of fluid through the pulsation control device is changed.

6. The device according to claim 1, wherein the flow is restricted, diverted, or modified in any way while traveling into, out of, or through the device.

7. The device according to claim 1, wherein the device uses an internal volume that is more compressible than the fluid being pumped.

8. The device according to claim 1, wherein each of the first flow control device and the second fluid control device have a constant internal diameter segment in a region farthest from the internal cavity.

9. The device according to claim 8, wherein each of the first flow control device and the second fluid control device have a tapered internal diameter segment in a region closest to the internal cavity.

10. The device according to claim 9, wherein each tapered internal diameter segment has a cross-section in a first region than a cross-section in a second region, and wherein the first region is closer to the internal cavity than the second region.
